(19) United States
(12) Patent Application Publication
(10) Pub. No.: US 2025/0041034 A1
(43) Pub. Date: Feb. 6, 2025

(54) SUCTION ENABLED DENTAL INSTRUMENT APPARATUS

(71) Applicant: The Regents of the University of California, Oakland, CA (US)

(72) Inventors: Petra Beate Wilder Smith, San Juan Capistrano, CA (US); Cherie Yvette Wink, Yorba Linda, CA (US); Tom Milner, Irvine, CA (US); Scott Jenney, Irvine, CA (US); Thair Takesh, Irvine, CA (US); Peter Jang, Garden Grove, CA (US); Benjamin Emerson Dolan, Laguna Niguel, CA (US)

(73) Assignee: The Regents of the University of California, Oakland, CA (US)

(21) Appl. No.: 18/697,365

(22) PCT Filed: Sep. 19, 2022
(86) PCT No.: PCT/US2022/043963

§ 371 Date: Mar. 29, 2024

Related U.S. Application Data
(60) Provisional application No. 63/251,148, filed on Oct. 1, 2021.

(51) Int. Cl. A61C 17/02; A61C 17/08

(52) U.S. Cl. CPC A61C 17/0208; A61C 17/08

(57) ABSTRACT

A suction enabled dental instrument apparatus is disclosed. In at least one embodiment, the apparatus provides an elongate handpiece having a working end and an opposing interface end. A terminal face of the working end of the handpiece provides an instrument opening sized and configured for allowing an instrument end of an instrument portion positioned within the handpiece to extend a distance therethrough. A main lumen is positioned within the handpiece in fluid communication with the instrument opening and a fluid source for selectively delivering a volume of fluid from the fluid source during use of the apparatus. At least one suction lumen is also positioned within the handpiece in fluid communication with the instrument opening and a suction source for capturing fluids and dental spray generated proximal to the instrument opening during use of the apparatus for the suction source to subsequently remove.

### RELATED APPLICATIONS

This application claims priority and is entitled to the filing date of U.S. provisional application Ser. No. 63/251,148, filed on Oct. 1, 2021. The contents of the aforementioned application are incorporated herein by reference.

### BACKGROUND

The subject of this patent application relates generally to dental devices, and more particularly to a suction enabled dental instrument apparatus configured for capturing dental spray during use of the dental instrument and reducing risk of airborne infections.

Applicant hereby incorporates herein by reference any and all patents and published patent applications cited or referred to in this application.

By way of background, there are many types of airborne infections that are primarily transported through splatter and droplet nuclei—including but not limited to COVID-19, tuberculosis, SARS, measles, hepatitis and herpetic viruses—and their potential to stay airborne or to become re-airborne as a dust particle is considered a major challenge to infection control in connection with dental procedures.

In dentistry, heat generating tools, such as high-frequency instrumentation for dental cleaning and rotary instrumentation for hard tissue ablation, use high-velocity air and water streams to provide cooling and maintain temperatures that remain below the thresholds of thermal damage for heat-sensitive dental tissues. Ultrasonic and sonic scalers produce the largest amount of spray emission among dental tools, followed by air-driven high-speed handpieces, drills, saws, air polishers, and instruments such as air-water syringe and prophylaxis handpieces—though manual dental instruments may also produce amounts of spray emission. Beyond simply air and water, these sprays may contain saliva, nasopharyngeal secretions, biofilm from plaque, oral and dental structures or water lines, blood, tooth components and any material used in the dental procedures. The contents of dental sprays historically have been divided into two categories: aerosol and splatter. Aerosol consists of particles less than 50 μm in diameter, which can remain airborne for extended periods of time. The smaller particles of an aerosol measuring 0.5 μm to 10 μm in diameter are considered particularly dangerous, as their ability to penetrate and lodge in the smaller passages of the lungs carries considerable potential for transmitting infection. Splatter consists of particles larger than 50 μm in diameter, which are too large to become suspended in the air, instead remaining airborne only briefly before falling to the ground. However, such splatter can become re-airborne as droplet nuclei, with the potential to enter the respiratory tract through leaks in face masks, or post-operatively after face masks have been removed. Splatter can also contact mucus membranes by going around protective devices such as safety glasses.

Several different types of devices have been developed in an attempt to solve these problems, yet none are ideal. For example, saliva ejectors are designed to remove unwanted saliva and other fluids from a patient's mouth during dental treatments; however, the suction power and bore diameter of saliva ejectors are typically inadequate for removing all types of dental sprays. High-volume evacuators (“HVE”) have relatively better suction power as compared to saliva ejectors. Often use of HVE requires four-handed dentistry or a second clinician to operate during dental procedures. Studies have demonstrated that a reduction of dental spray, both aerosol and spatter, is only effective if a large-bore (having an inner diameter measuring at least 8 to 10 millimeters) HVE is placed within 0.6-2 cm of the power driven instrument working tip. Because of the physical configuration of current power driven scalers, and anatomical constraints, this is very often not possible; and even where it is possible, it is often impractical. Single use extra-oral evacuators are also not very effective given that the point of suction is often positioned relatively too far away from the dental spray generation source, and they also tend to get in the way of the operator during dental procedures. Other suction devices have been configured for attaching externally to the handpiece of the dental instrument; however, such configurations result in the point of suction being positioned external and adjacent to the working end of the dental instrument, thereby inhibiting the working ability or positioning of the dental instrument in the hand and potentially also obstructing the view of the operator. Other external suction devices involve placing a large apparatus chairside in which the intake port must be positioned roughly 4 inches from the patient's oral cavity to reduce some aerosol and spatter from the level of the clinician's eye level downward. These large machines limit the clinician's ability to work from the necessary positions that would otherwise ensure proper ergonomic practices.

Accordingly, there remains a need for a suction system capable of effectively capturing dental spray without inhibiting the working ability of the dental instrument or the operator. Aspects of the present invention fulfill these needs and provide further related advantages as described in the following summary.

Aspects of the present invention fulfill these needs and provide further related advantages as described in the following summary.

It should be noted that the above background description includes information that may be useful in understanding aspects of the present invention. It is not an admission that any of the information provided herein is prior art or relevant to the presently claimed invention, or that any publication specifically or implicitly referenced is prior art.

### SUMMARY

Aspects of the present invention teach certain benefits in construction and use which give rise to the exemplary advantages described below.

The present invention solves the problems described above by providing a suction enabled dental instrument apparatus configured for capturing dental spray during use of the dental instrument and reducing risk of airborne infections. In at least one embodiment, the apparatus provides an elongate handpiece having a working end and an opposing interface end. A terminal face of the working end of the handpiece provides an instrument opening sized and configured for allowing an instrument end of an instrument portion positioned within the handpiece to extend a distance therethrough. A main lumen is positioned within the handpiece and extends between a main outlet end, positioned adjacent to and in fluid communication with the instrument opening, and an opposing main inlet end, positioned proximal to the interface end of the handpiece and in fluid communication with a fluid source, the main outlet end configured for selectively delivering a volume of fluid from the fluid source during use of the apparatus. An at least one suction lumen is positioned within the handpiece and extends between a suction inlet end, positioned adjacent to and in fluid communication with the instrument opening, and an opposing suction outlet end, positioned proximal to the interface end of the handpiece and in fluid communication with a suction source, the suction inlet end configured for capturing fluids and dental spray generated proximal to the instrument opening during use of the apparatus for the suction source to subsequently remove via the suction outlet end.

Other features and advantages of aspects of the present invention will become apparent from the following more detailed description, taken in conjunction with the accompanying drawings, which illustrate, by way of example, the principles of aspects of the invention.

### BRIEF DESCRIPTION OF THE DRAWINGS

The accompanying drawings illustrate aspects of the present invention. In such drawings:

FIG. 1 is a perspective view of an exemplary suction enabled dental instrument apparatus, in accordance with at least one embodiment;

FIG. 2 is an exploded perspective view thereof, in accordance with at least one embodiment;

FIG. 3 is a further perspective view thereof, with select portions cut away for illustrative purposes, in accordance with at least one embodiment;

FIG. 4 is a cross-sectional view taken along line 4-4 of FIG. 1;

FIG. 5 is a perspective view of an exemplary nozzle portion of the apparatus, in accordance with at least one embodiment;

FIG. 6 is a cross-sectional view taken along line 6-6 of FIG. 5;

FIG. 7 is a perspective view of a further exemplary suction enabled dental instrument apparatus, in accordance with at least one embodiment;

FIG. 8 is a further perspective view thereof, with selection portions cut away and an inner suction lumen and main lumen omitted for illustrative purposes, in accordance with at least one embodiment;

FIG. 9 is a cross-sectional view taken along line 9-9 of FIG. 7;

FIG. 10 is a front elevational view thereof, in accordance with at least one embodiment;

FIG. 11 is a side elevational view thereof, in accordance with at least one embodiment;

FIG. 12 is a perspective view of a still further exemplary suction enabled dental instrument apparatus, in accordance with at least one embodiment;

FIG. 13 is a cross-sectional view taken along line 13-13 of FIG. 12;

FIG. 14 is a perspective view of an exemplary suction lumen and main lumen with selection portions cut away for illustrative purposes, in accordance with at least one embodiment; and

FIGS. 15-19 are block diagrams of exemplary embodiments of the suction enabled dental instrument apparatus.

The above described drawing figures illustrate aspects of the invention in at least one of its exemplary embodiments, which are further defined in detail in the following description. Features, elements, and aspects of the invention that are referenced by the same numerals in different figures represent the same, equivalent, or similar features, elements, or aspects, in accordance with one or more embodiments.

### DETAILED DESCRIPTION

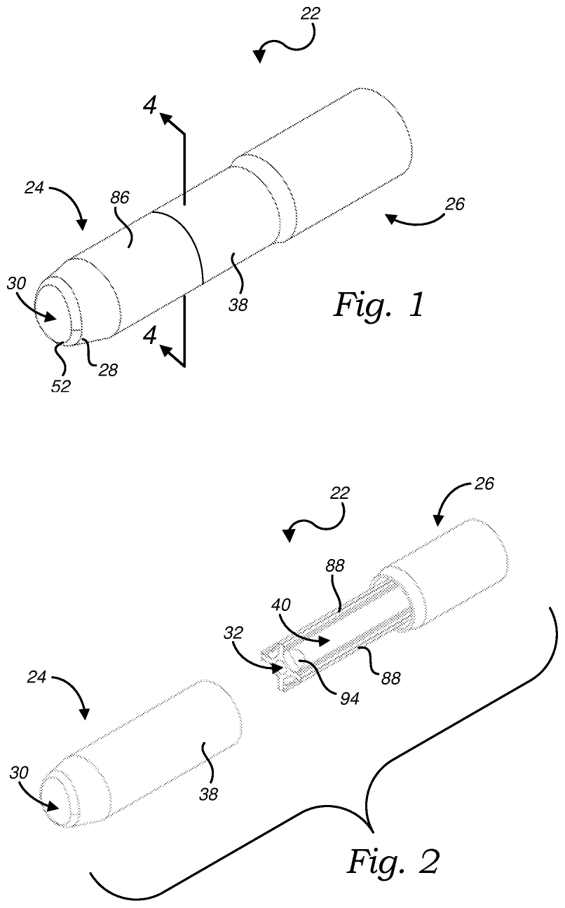

Turning now to FIG. 1, there is shown a perspective view of an exemplary embodiment of a suction enabled dental instrument apparatus 20. At the outset, it should be noted that the term “ultrasonic” as used herein is intended to encompass dental instruments that utilize electromagnetic, magnetostrictive, sonic, and piezoelectric energy, along with any other form of energy (now known or later developed) capable of causing the dental instrument to vibrate at a desired frequency. However, it should also be noted that the apparatus 20 may be utilized in connection with any other type of mechanical or manual dental instruments now known or later developed as well, including but in no way limited to air-driven high-speed handpiece 22s, drills, saws, air polishers, and instruments such as air-water syringe and prophylaxis handpiece 22s. Thus, while the apparatus 20 might be shown and described herein in the context of specific types of dental instruments (namely, dental scalers) for illustrative purposes, the apparatus 20 should not be read as being so limited. It should also be noted that the term “dental spray” as used herein is intended to encompass aerosol, vapor, splatter, and droplet emissions.

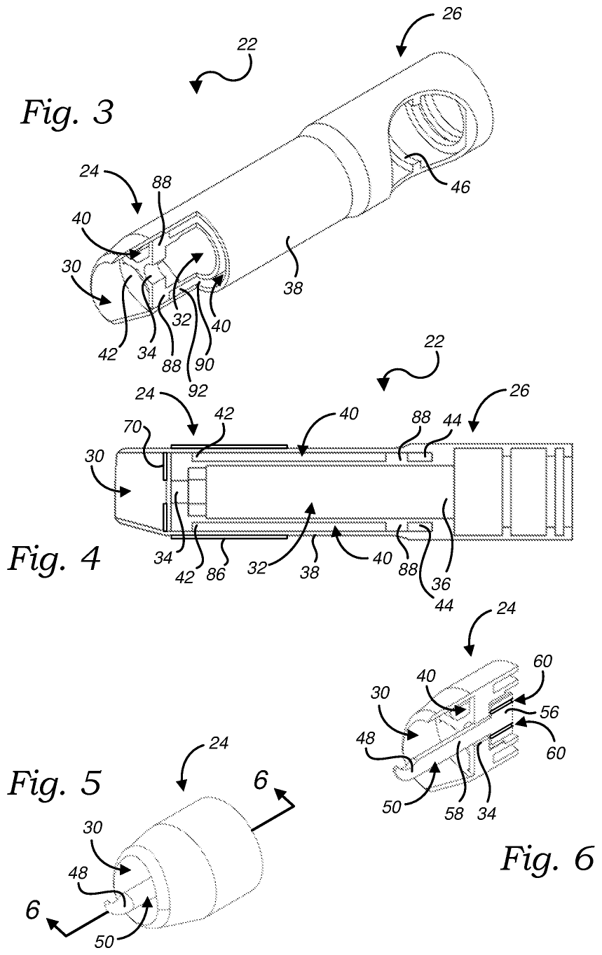

With continued reference to FIG. 1, in at least one embodiment, the apparatus 20 provides an elongate handpiece 22 having a working end 24 and an opposing interface end 26. In at least one embodiment, a terminal face 28 of the working end 24 of the handpiece 22 provides an instrument opening 30, as discussed further below. In at least one embodiment, as best illustrated in FIGS. 3 and 4, the handpiece 22 provides a main lumen 32 positioned within the handpiece 22 and extending between a main outlet end 34, positioned adjacent to and in fluid communication with the instrument opening 30, and an opposing main inlet end 36, positioned on an outer surface 28 of the handpiece 22 at or proximal to the interface end 26 of the handpiece 22. Additionally, in at least one embodiment, the handpiece 22 further provides an at least one suction lumen 40 positioned within the handpiece 22 and extending between a suction inlet end 42 in direct fluid communication with the instrument opening 30 and an opposing suction outlet end 44 positioned on the outer surface 28 of the handpiece 22 at or proximal to the interface end 26 of the handpiece 22. In at least one embodiment, the at least one suction lumen 40 is radially offset from main lumen 32. Thus, in at least one such embodiment, where the handpiece 22 provides a plurality of suction lumens 40, the suction lumens 40 are arranged circumferentially about the main lumen 32. In at least one further embodiment, as illustrated in FIG. 14, the main lumen 32 is substantially coaxially positioned within the suction lumen 40. In at least one such embodiment, the suction lumen 40 (along with the coaxially positioned main lumen 32) is substantially tubular shaped and configured for being removably inserted within the handpiece 22. Additionally, in at least one such embodiment, the apparatus 20 provides a locking mechanism 46 positioned and configured for selectively securing the suction lumen 40 and main lumen 32 within the handpiece 22 and preventing the suction lumen 40 and main lumen 32 from becoming unintentionally disengaged from the handpiece 22 during use of the apparatus 20. In at least one embodiment, the main lumen 32 is concentrically positioned within the handpiece 22. However, in at least one alternate embodiment, the main lumen 32 is non-concentrically positioned within the handpiece 22. In that regard, it should be noted that the handpiece 22 depicted in the drawings is merely exemplary and is shown for illustrative purposes. Accordingly, in further embodiments, the handpiece 22 may take on any other sizes, shapes and/or dimensions now known or later developed—dependent at least in part on the specific context in which the apparatus 20 is to be utilized—so long as the apparatus 20 is able to substantially carry out the functionality described herein. Similarly, each of the various components of the handpiece 22 (including but not limited to the instrument opening 30, main lumen 32 and at least one suction lumen 40) may take on any other sizes, shapes, dimensions, quantities and/or relative positions now known or later developed—dependent at least in part on the specific context in which the apparatus 20 is to be utilized—so long as the apparatus 20 is able to substantially carry out the functionality described herein.

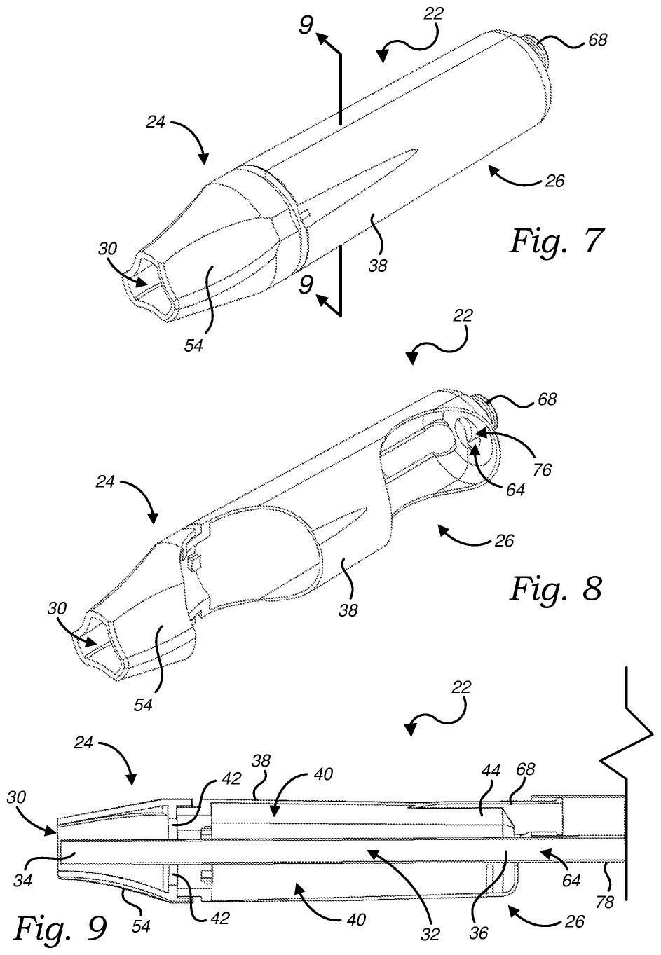

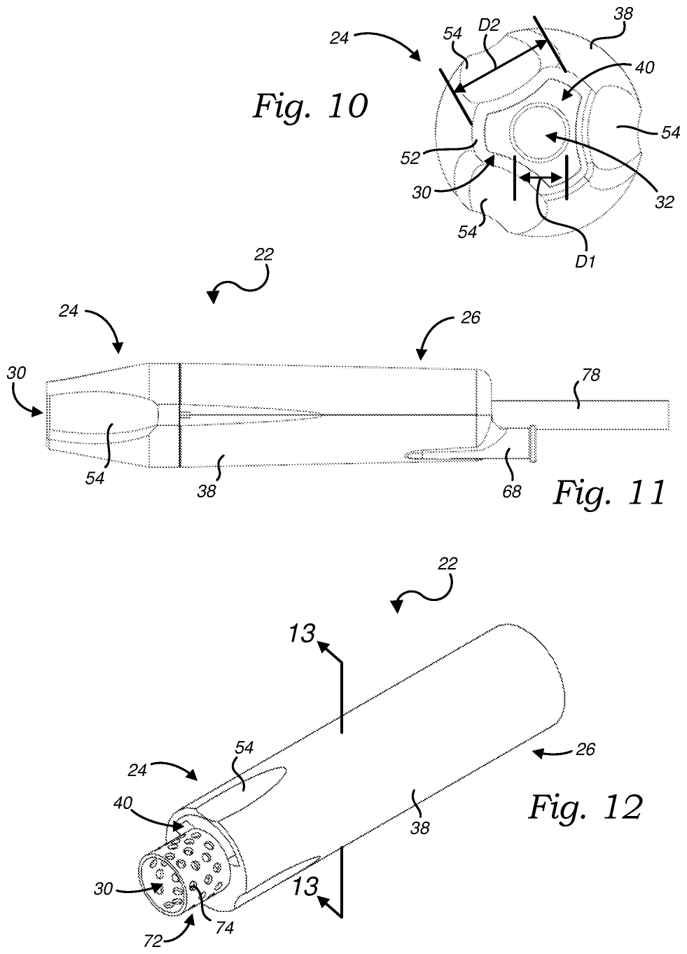

In at least one embodiment, the instrument opening 30 is in fluid communication with each of the main lumen 32 and at least one suction lumen 40. Additionally, in at least one embodiment, the instrument opening 30 is sized and configured for capturing any fluids or dental spray that might be generated during use of the apparatus 20, as discussed further below. As best illustrated in FIGS. 5 and 6, the instrument opening 30 is further configured for allowing an instrument end 48 of an instrument portion 50 (such as a scaler, for example) to extend a distance through the instrument opening 30, so as to maintain the instrument opening 30 within an optimal distance from the instrument end 48 in order to increase dental spray removal during use of the apparatus 20. In that regard, it has been found that this dental spray reducing arrangement of the instrument opening 30 and the instrument end 48 does not result in overheating of the instrument end 48 or the surrounding, very thermally sensitive, dental hard and soft tissues within the patient's mouth. In at least one embodiment, the instrument end 48 of the instrument portion 50 extends approximately 0.6-2.0 cm beyond the terminal face 28 of the working end 24 of the handpiece 22; however, in further embodiments, the instrument end 48 may extend any other distance beyond the terminal face 28, dependent at least in part on the specific configuration of the instrument portion 50 and the context in which the apparatus 20 is to be utilized. In that regard, in further embodiments, the instrument portion 50 may take on any other sizes, shapes, dimensions, and/or configurations now known or later developed (i.e., not just scalers, but any other types of dental instruments now known or later developed)—dependent at least in part on the specific context in which the apparatus 20 is to be utilized—so long as the apparatus 20 is able to substantially carry out the functionality described herein. Additionally, in at least one embodiment, the instrument portion 50 is substantially coaxially positioned within the main lumen 32, such that a perimeter edge 52 of the instrument opening 30 is radially spaced apart from and extends circumferentially about the instrument end 48 of the instrument portion 50. In at least one such embodiment, a radial space between the perimeter edge 52 of the instrument opening 30 and the instrument end 48 is approximately 1.0-5.0 millimeters wide. However, in further embodiments, the radial space may be less than 1.0 millimeter wide or greater than 5.0 millimeters wide, dependent at least in part on the specific configuration of the instrument portion 50 and the context in which the apparatus 20 is to be utilized. Additionally, while the instrument opening 30 is substantially circular in at least one embodiment (such as the embodiment depicted in FIGS. 1-6, for example), in at least one alternate embodiment (such as the embodiment depicted in FIGS. 7-11, for example), the instrument opening 30 is substantially non-circular so as to facilitate the capture and removal of fluids and dental spray while also allowing for optimal operability and vision for the user. In at least one such embodiment, as illustrated in FIGS. 7-11, the working end 24 of the handpiece 22 is tapered toward the instrument opening 30, with an outer surface 28 of the working end 24 (along with the perimeter edge 52 of the instrument opening 30) defining a plurality of circumferentially arranged indentations 54 extending substantially longitudinally from the instrument opening 30 toward the interface end 26 of the handpiece 22. It should be noted that, in further embodiments, the indentations 54 may take on any other sizes, shapes, dimensions, quantities and/or relative positions now known or later developed—dependent at least in part on the specific configuration of the instrument portion 50 and the context in which the apparatus 20 is to be utilized—so long as the apparatus 20 is able to substantially carry out the functionality described herein.

In at least one embodiment, the instrument portion 50 is removably engageable with the working end 24; however, in at least one alternate embodiment, the instrument portion 50 is permanently secured or otherwise integral with the working end 24. In at least one embodiment, as best illustrated in FIG. 6, a base 56 of the instrument portion 50 is positioned within the main lumen 32, with the base 56 having an outer diameter that is relatively greater than an inner diameter of the main outlet end 34 of the main lumen 32, thereby preventing the base 56 from passing through the main outlet end 34 of the main lumen 32 which, in turn, prevents the instrument portion 50 from becoming unintentionally disengaged from the working end 24. Additionally, in at least one embodiment, the base 56 is non-circular (such as hex-shaped, for example) and configured for indexing into a similarly shaped portion of the main lumen 32, which prevents the instrument portion 50 from unintentionally rotating during use of the apparatus 20. In at least one embodiment, an instrument shaft 58 extends between and interconnects the instrument end 48 and the base 56, with the instrument shaft 58 having an outer diameter that is relatively less than the inner diameter of the main outlet end 34 of the main lumen 32. In such embodiments, the instrument shaft 58 is substantially coaxially positioned within the main outlet end 34 of the main lumen 32, such that the main outlet end 34 is radially spaced apart from and extends circumferentially about the instrument shaft 58, thereby maintaining fluid communication between the instrument opening 30 and the main lumen 32. In at least one further embodiment, the base 56 of the instrument portion 50 provides an at least one instrument aperture 60 extending therethrough in a direction substantially parallel with the main lumen 32 for facilitating the fluid communication between the instrument opening 30 and the main lumen 32.

As noted above, in at least one embodiment, the main lumen 32 is in fluid communication with the instrument opening 30. Specifically, the main outlet end 34 of the main lumen 32 is in direct fluid communication with the instrument opening 30. Additionally, in at least one embodiment, the opposing main inlet end 36 of the main lumen 32 is in fluid communication with a fluid source 62 configured for selectively delivering a volume of fluid (such as water, for example) through the main lumen 32 and subsequently out the instrument opening 30 (or alternatively, onto the instrument end 48 of the instrument portion 50) during use of the apparatus 20. In at least one embodiment, the fluid source 62 is located external to the handpiece 22, such as a water line or central dental unit water supply, for example. In at least one alternate embodiment, the fluid source 62 is positioned within the handpiece 22, such as a fluid reservoir and pump, for example. In at least one embodiment, where the fluid source 62 is located external to the handpiece 22, the interface end 26 of the handpiece 22 provides a fluid port 64 (FIGS. 8, 9 and 11) engaged with the main inlet end 36 of the main lumen 32 and configured for establishing a fluid communication between the main lumen 32 and the fluid source 62. In at least one alternate embodiment, where the fluid source 62 is positioned within the handpiece 22, the fluid port 64 may be omitted. In at least one embodiment, the main lumen 32 has an inner diameter D1 of approximately 1/24 inch-2 inches; however, in further embodiments, the main lumen 32 may have an inner diameter D1 of less than 1/24 inch or greater than 2 inches—dependent at least in part on the specific context in which the apparatus 20 is to be utilized.

In at least one embodiment, the apparatus 20 further provides a heating unit (not shown) positioned inline between the fluid source 62 and the main outlet end 34 of the main lumen 32, the heating unit configured for heating the fluid to a comfortable temperature before it comes into contact with the patient's mouth. In at least one such embodiment, the heating unit is positioned within the handpiece 22, inline between the main outlet end 34 and the fluid port 64. In at least one alternate such embodiment, the heating unit is located external to the handpiece 22, inline between the fluid port 64 and the fluid source 62.

As noted above, in at least one embodiment, the at least one suction lumen 40 is in fluid communication with the instrument opening 30. Specifically, the suction inlet end 42 of the at least one suction lumen 40 is in direct fluid communication with the instrument opening 30. Additionally, in at least one embodiment, the opposing suction outlet end 44 of the at least one suction lumen 40 is in fluid communication with a suction source 66 configured for selectively capturing any fluids or dental spray that might be generated proximal to the instrument opening 30 during use of the apparatus 20, and subsequently moving any such fluids and/or dental spray through the suction inlet end 42 of the at least one suction lumen 40, through the at least one suction lumen 40, and out the suction outlet end 44 of the at least one suction lumen 40. In such embodiments, the suction source 66 is optimized to provide the correct vacuum parameters to eliminate dental spray without excising force that might impact the oral tissues of the patient. In at least one embodiment, the suction source 66 is located external to the handpiece 22, such as an HVE, for example. In at least one alternate embodiment, the suction source 66 is positioned within the handpiece 22. In at least one embodiment, where the suction source 66 is located external to the handpiece 22, the interface end 26 of the handpiece 22 provides a suction port 68 (FIGS. 8, 9 and 11) engaged with the suction outlet end 44 of the at least one suction lumen 40 and configured for establishing a fluid communication between the at least one suction lumen 40 and the suction source 66. In at least one alternate embodiment, where the suction source 66 is positioned within the handpiece 22, the suction port 68 may be omitted. In at least one embodiment, the at least one suction lumen 40 has an inner diameter D2 of approximately ¼ inch-2 inches; however, in further embodiments, the at least one suction lumen 40 may have an inner diameter D2 of less than ¼ inch or greater than 2 inches—dependent at least in part on the specific context in which the apparatus 20 is to be utilized.

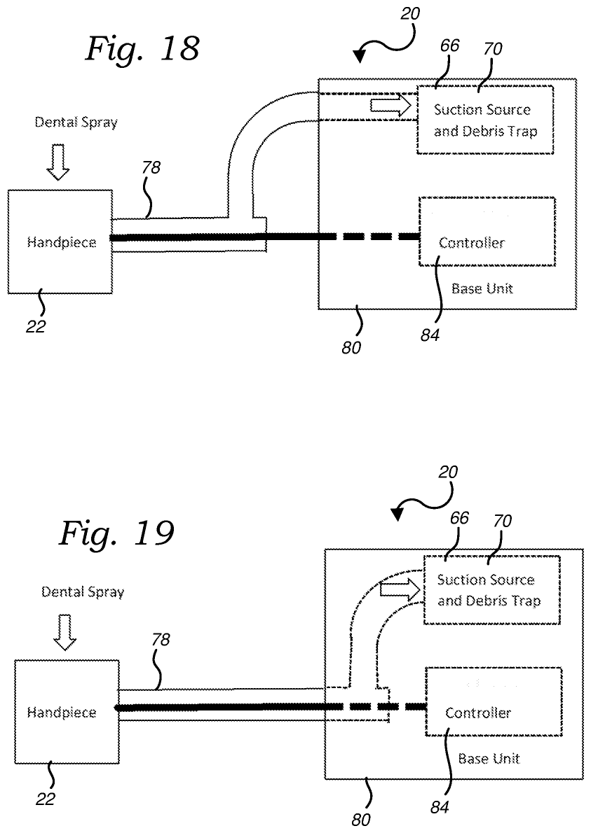

In at least one embodiment, as best illustrated in FIG. 4, the handpiece 22 further provides an at least one debris trap 70 positioned in-line between the instrument opening 30 and the suction source 66, the at least one debris trap 70 configured for capturing any debris that might be sucked into the instrument opening 30. In at least one embodiment, as illustrated in FIGS. 18 and 19, where the suction source 66 is located external to the handpiece 22, the at least one debris trap 70 is also positioned external to the handpiece 22, in-line between the suction port 68 and the suction source 66.

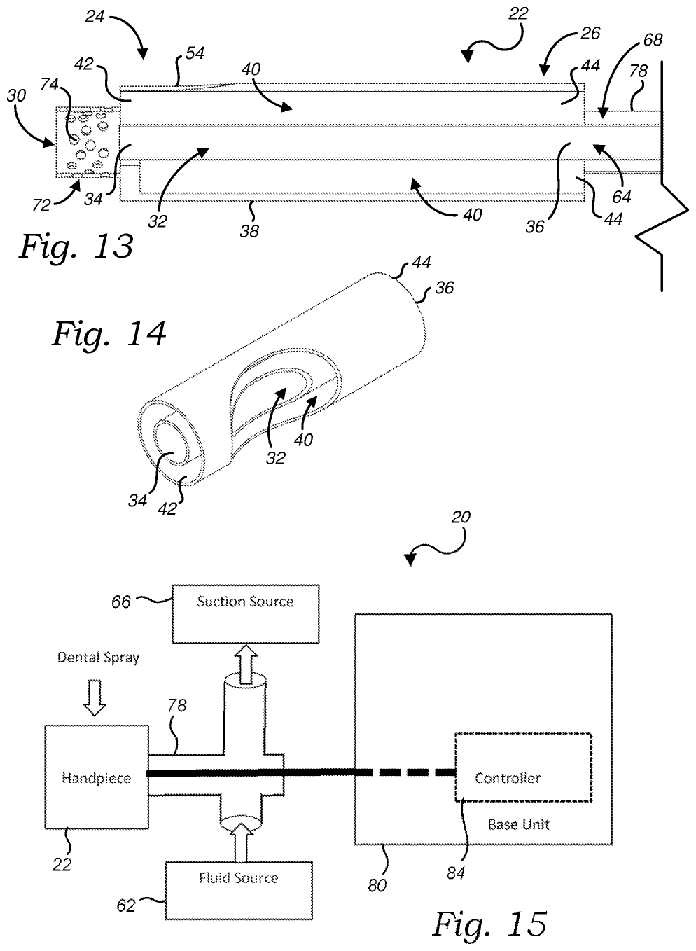

In at least one embodiment, as best illustrated in FIGS. 12 and 13, the handpiece 22 further provides a porous nozzle 72 positioned within the instrument opening 30 and providing a plurality of circumferentially arranged nozzle apertures 74 sized and configured for assisting with the capture of dental spray particles during use of the apparatus 20. It should be noted that the nozzle, along with the corresponding nozzle apertures 74, may take on any other sizes, shapes, dimensions and/or configurations now known or later developed—dependent at least in part on the specific configuration of the instrument portion 50 and the context in which the apparatus 20 is to be utilized—so long as the apparatus 20 is able to substantially carry out the functionality described herein. With continued reference to FIGS. 12 and 13, in at least one embodiment, the instrument opening 30 is shaped as a semicircle positioned above and coterminous with a relatively smaller circle so as to account for an uneven spreading of dental spray particles biased toward the instrument end 48 of the instrument portion 50.

In at least one embodiment, where the instrument portion 50 is configured for being electrically powered (or alternatively, where the fluid source 62 and/or suction source 66 is positioned within the handpiece 22), the interface end 26 of the handpiece 22 provides an electrical port 76 (FIGS. 8, 9 and 11) in electrical communication with an at least one power source (not shown) located external to the handpiece 22 (such as an electrical outlet, for example) for selectively powering the apparatus 20. In at least one alternate embodiment, the power source is positioned within handpiece 22 (such as a replaceable or rechargeable battery, for example), such that the electrical port 76 may be omitted.

In at least one embodiment, as best illustrated in FIGS. 8, 9 and 11, one or more of the electrical port 76, fluid port 64 and suction port 68 are positioned within a single conduit 78 extending from the interface end 26 of the handpiece 22. In at least one such embodiment, the conduit 78 is in fluid communication with the externally located suction source 66, with the fluid port 64 and/or electrical port 76 being positioned within the conduit 78. In that regard, it should be noted that the sizes, shapes, dimensions, quantities and relative positions of each of the electrical port 76, fluid port 64 and suction port 68 depicted in the drawings are merely illustrative, such that in further embodiments, each of the electrical port 76, fluid port 64 and suction port 68 may take on any other sizes, shapes, dimensions, quantities and/or relative positions (including positions on the handpiece 22 other than the interface end 26) now known or later developed, so long as the apparatus 20 is capable of substantially carrying out the functionality described herein.

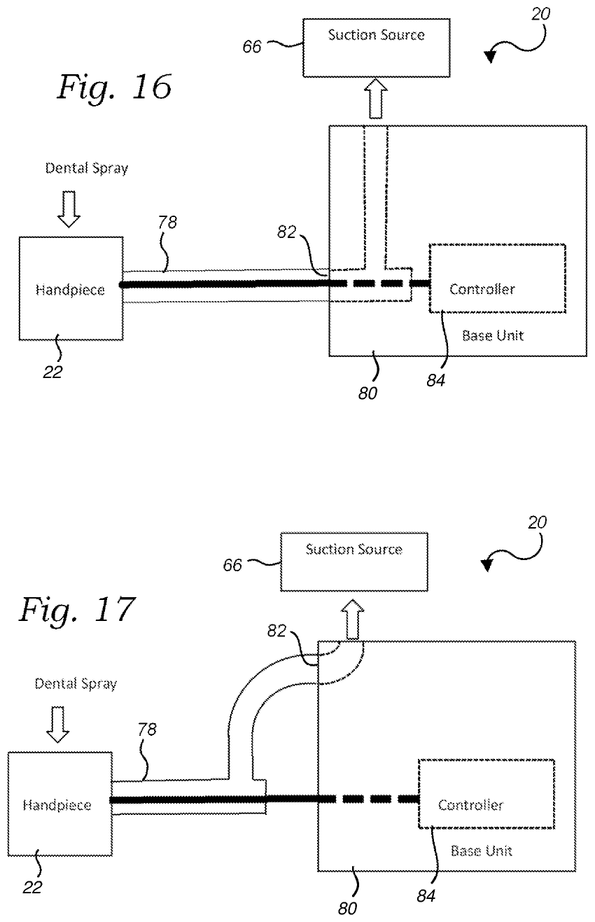

In at least one embodiment, where the fluid source 62 is located external to the handpiece 22, the fluid source 62 may be positioned within a separate base unit 80 of the apparatus 20 in fluid communication with the fluid port 64. Similarly, in at least one embodiment, where the suction source 66 is located external to the handpiece 22, as illustrated in FIGS. 18 and 19, the suction source 66 may be positioned within the base unit 80 (along with the debris trap 70, in at least one embodiment) in fluid communication with the suction port 68. In at least one alternate embodiment, as illustrated in FIGS. 16 and 17, the suction source 66 is located external to both the handpiece 22 and the base unit 80, while a base unit suction port 82 is positioned within the base unit 80 and configured for establishing fluid communication between the suction source 66 and the suction port 68. In at least one embodiment, as illustrated in FIGS. 15-19, a controller 84 may be positioned within the base unit 80 in electrical communication with the electrical port 76 for selectively controlling one or more of the instrument portion 50 (where the instrument portion 50 is configured for being electrically powered), fluid source 62 or suction source 66. Additionally, in at least one embodiment, the power source may be positioned within the base portion as well.

In at least one embodiment, the outer surface 28 of the handpiece 22 provides ergonomic features, such as an appropriately positioned resilient, soft, deformable grip portion 86 positioned and configured for increasing comfort, reducing vibration transmission, and reducing muscle activity in the user's hand during use of the apparatus 20, while also preserving manual dexterity. In at least one embodiment, the grip portion 86 is constructed out of a material (or combination of materials) that is relatively soft, lightweight, and thermally insulated. Additionally, in at least one embodiment, the grip portion 86 is constructed out of a material that is compatible with human tissue and body fluids, with said material being odorless, tasteless, and capable of preventing bacteria growth thereon. Additionally, in at least one embodiment, the grip portion 86 is constructed out of a material (or combination of materials) that is capable of withstanding repeated heat sterilization. In at least one such embodiment, the grip portion 86 is constructed out of a silicone, such as a silicone having a shore hardness of −35-70+/−5 on the Shore A scale, for example. In further embodiments, the grip portion 86 is constructed out of a rubber/elastomer, or a plastic material. In still further embodiments, the grip portion 86 may be constructed out of any other materials (or combinations of materials), now known or later developed, that are capable of allowing the grip portion 86 to substantially carry out the functionality described herein—dependent at least in part on the specific configuration of the instrument portion 50 and the context in which the apparatus 20 is to be utilized. In at least one embodiment, the grip portion 86 is constructed as an elongate, substantially cylindrical-shaped structure. In further embodiments, the grip portion 86 may be constructed as any other shapes (and having any other dimensions and thicknesses), now known or later developed, that are capable of allowing the grip portion 86 to substantially carry out the functionality described herein. Similarly, in further embodiments, the grip portion 86 may be positioned anywhere else on the handpiece 22, now known or later conceived—dependent at least in part on the specific configuration of the instrument portion 50 and the context in which the apparatus 20 is to be utilized. Additionally, in at least one embodiment, an outer surface 28 of the grip portion 86 may be textured for improving grip and increasing surface area contact of the user's finger tips. Additives may also or alternatively be included, such as to provide a non-slip surface(s), increase or decrease stretch, tensile strengths, elongation capabilities, hardness, tear strength, resiliency, tolerance of sterilization, etc.

In at least one embodiment, the working end 24 of the handpiece 22 is removably engageable with the interface end 26 of the handpiece 22, which allows one or both of the working end 24 and interface end 26 to be constructed out of disposable materials in at least one such embodiment. In at least one embodiment, as illustrated best in FIG. 2, the interface end 26 of the handpiece 22 provides a plurality of radially arranged rails 88 configured for frictionally engaging a circumferential inner surface 90 of the working end 24 of the handpiece 22 when the working end 24 is slid overtop of the rails 88. In at least one such embodiment, the inner surface 90 of the working end 24 provides a plurality of corresponding slots 92 (FIG. 3) positioned and configured for slidably receiving the rails 88 of the interface end 26. Additionally, in at least one embodiment, when the working end 24 is frictionally engaged with the interface end 26, the inner surface 90 of the working end 24 cooperates with the spaces between the rails 88 to define the at least one suction lumen 40. In at least one such embodiment, the suction inlet end 42 of each of the at least one suction lumen 40 provides a chamfered edge 94 so as to optimize airflow for dental spray removal during use of the apparatus 20. In at least one alternate embodiment, the working end 24 and interface end 26 may be removably engaged with one another using any other mechanism, structure or technique now known or later developed—dependent at least in part on the specific configuration of the instrument portion 50 and the context in which the apparatus 20 is to be utilized—so long as the apparatus 20 is capable of substantially carrying out the functionality described herein. In at least one further alternate embodiment, the working end 24 and interface end 26 are permanently secured to one another, such that the handpiece 22 is a single unitary structure.

Accordingly, in at least one embodiment, the apparatus 20 allows for evacuation of ultrasonication-induced aerosol and other dental spray very close to its source by effective suction incorporated directly into the handpiece 22 of the apparatus 20, and is capable of achieving at least 80-90% reduction in aerosol, and at least 50-90% reduction in splatter emissions during dental procedures. In this way the apparatus 20 avoids (1) the need for two-handed operation by a single operator (which is undesirable because of musculoskeletal strain and inability to maintain suction at optimal/effective distance from the instrument end 48 of the instrument portion 50), (2) discomfort and poor access caused by overcrowding of the patient's mouth by multiple hands in the mouth to work on and use HVE, (3) the need for a second pair of hands to hold a separate suction device, (4) the need for an external anchoring mechanism for the separate suction device, and (5) the need for an external suction nozzle externally attached to the handpiece 22. Furthermore, the apparatus 20 (1) protects patient, clinician and bystanders from infectious dental spray, (2) reduces distance and amount of contamination of adjacent structures such as floors, walls, lights, dental equipment, (3) improves clinicians' visual access to the working area, and (4) improves patient comfort and acceptance of treatment.

Aspects of the present specification may also be described as the following embodiments:

1. A suction enabled dental instrument apparatus comprising: an elongate handpiece having a working end and an opposing interface end; a terminal face of the working end of the handpiece providing an instrument opening sized and configured for allowing an instrument end of an instrument portion positioned within the handpiece to extend a distance therethrough; a main lumen positioned within the handpiece and extending between a main outlet end, positioned adjacent to and in fluid communication with the instrument opening, and an opposing main inlet end, positioned proximal to the interface end of the handpiece and in fluid communication with a fluid source, the main outlet end configured for selectively delivering a volume of fluid from the fluid source during use of the apparatus; and an at least one suction lumen positioned within the handpiece and extending between a suction inlet end, positioned adjacent to and in fluid communication with the instrument opening, and an opposing suction outlet end, positioned proximal to the interface end of the handpiece and in fluid communication with a suction source, the suction inlet end configured for capturing fluids and dental spray generated proximal to the instrument opening during use of the apparatus for the suction source to subsequently remove via the suction outlet end.

2. The suction enabled dental instrument apparatus according to embodiment 1, wherein the at least one suction lumen is radially offset from main lumen.

3. The suction enabled dental instrument apparatus according to embodiments 1-2, further comprising a plurality of suction lumens positioned within the handpiece, the suction lumens being arranged circumferentially about the main lumen.

4. The suction enabled dental instrument apparatus according to embodiments 1-3, wherein the main lumen is substantially coaxially positioned within the suction lumen.

5. The suction enabled dental instrument apparatus according to embodiments 1-4, wherein the suction lumen and substantially coaxial main lumen are substantially tubular shaped and configured for being removably inserted within the handpiece.

6. The suction enabled dental instrument apparatus according to embodiments 1-5, further comprising a locking mechanism positioned and configured for selectively securing the suction lumen and main lumen within the handpiece and preventing the suction lumen and main lumen from becoming unintentionally disengaged from the handpiece during use of the apparatus.

7. The suction enabled dental instrument apparatus according to embodiments 1-6, wherein the instrument end of the instrument portion extends approximately 0.6-2.0 cm beyond the terminal face of the working end of the handpiece.

8. The suction enabled dental instrument apparatus according to embodiments 1-7, wherein the instrument portion is substantially coaxially positioned within the main outlet end of the main lumen, such that a perimeter edge of the instrument opening is radially spaced apart from and extends circumferentially about the instrument end of the instrument portion.

9. The suction enabled dental instrument apparatus according to embodiments 1-8, wherein a radial space between the perimeter edge of the instrument opening and the instrument end has a width of approximately 1.0-5.0 millimeters.

10. The suction enabled dental instrument apparatus according to embodiments 1-9, wherein the instrument opening has a shape that is substantially circular.

11. The suction enabled dental instrument apparatus according to embodiments 1-10, wherein the instrument opening has a shape that is substantially non-circular.

12. The suction enabled dental instrument apparatus according to embodiments 1-11, wherein the working end of the handpiece is tapered toward the instrument opening.

13. The suction enabled dental instrument apparatus according to embodiments 1-12, wherein an outer surface of the working end and a perimeter edge of the instrument opening define a plurality of circumferentially arranged indentations extending substantially longitudinally from the instrument opening toward the interface end of the handpiece.

14. The suction enabled dental instrument apparatus according to embodiments 1-13, wherein the instrument portion is permanently secured or otherwise integral with the working end.

15. The suction enabled dental instrument apparatus according to embodiments 1-14, wherein the instrument portion is removably engageable with the working end of the handpiece.

16. The suction enabled dental instrument apparatus according to embodiments 1-15, wherein a base of the instrument portion is positioned within the main lumen, the base having an outer diameter that is relatively greater than an inner diameter of the main outlet end of the main lumen, thereby preventing the base from passing through the main outlet end of the main lumen.

17. The suction enabled dental instrument apparatus according to embodiments 1-16, wherein the base is substantially non-circular and configured for indexing into a similarly shaped portion of the main lumen, thereby preventing the instrument portion from unintentionally rotating within the main lumen during use of the apparatus.

18. The suction enabled dental instrument apparatus according to embodiments 1-17, wherein the instrument portion provides an instrument shaft extending between and interconnecting the instrument end and the base, the instrument shaft having an outer diameter that is relatively less than an inner diameter of the main outlet end of the main lumen.

19. The suction enabled dental instrument apparatus according to embodiments 1-18, wherein the instrument shaft is substantially coaxially positioned within the main outlet end of the main lumen, such that the main outlet end is radially spaced apart from and extends circumferentially about the instrument shaft, thereby maintaining fluid communication between the instrument opening and the main lumen.

20. The suction enabled dental instrument apparatus according to embodiments 1-19, wherein the base of the instrument portion provides an at least one instrument aperture extending therethrough in a direction substantially parallel with the main lumen for facilitating the fluid communication between the instrument opening and the main lumen.

21. The suction enabled dental instrument apparatus according to embodiments 1-20, wherein the fluid source is located external to the handpiece.

22. The suction enabled dental instrument apparatus according to embodiments 1-21, wherein the interface end of the handpiece provides a fluid port engaged with the main inlet end of the main lumen and configured for establishing a fluid communication between the main lumen and the fluid source.

23. The suction enabled dental instrument apparatus according to embodiments 1-22, further comprising a base unit located externally from the handpiece and configured for housing the fluid source.

24. The suction enabled dental instrument apparatus according to embodiments 1-23, wherein the fluid source is positioned within the handpiece.

25. The suction enabled dental instrument apparatus according to embodiments 1-24, further comprising a heating unit positioned inline between the fluid source and the main outlet end of the main lumen, the heating unit configured for heating the fluid to a comfortable temperature during use of the apparatus.

26. The suction enabled dental instrument apparatus according to embodiments 1-25, wherein the suction source is located external to the handpiece.

27. The suction enabled dental instrument apparatus according to embodiments 1-26, wherein the interface end of the handpiece provides a suction port engaged with the suction outlet end of the at least one suction lumen and configured for establishing a fluid communication between the at least one suction lumen and the suction source.

28. The suction enabled dental instrument apparatus according to embodiments 1-27, further comprising a base unit located externally from the handpiece and configured for housing the suction source.

29. The suction enabled dental instrument apparatus according to embodiments 1-28, further comprising a base unit located externally from the handpiece and providing a base unit suction port configured for establishing fluid communication between the suction source and the suction port.

30. The suction enabled dental instrument apparatus according to embodiments 1-29, wherein the base unit further provides a controller in electrical communication with the electrical port for selectively controlling one or more of the instrument portion, fluid source and suction source.

31. The suction enabled dental instrument apparatus according to embodiments 1-30, wherein the suction source is positioned within the handpiece.

32. The suction enabled dental instrument apparatus according to embodiments 1-31, further comprising an at least one debris trap positioned in-line between the instrument opening and the suction source, the at least one debris trap configured for capturing any debris that might be sucked into the instrument opening via the at least one suction lumen.

33. The suction enabled dental instrument apparatus according to embodiments 1-32, further comprising a porous nozzle positioned within the instrument opening and providing a plurality of circumferentially arranged nozzle apertures sized and configured for assisting with the capture of dental spray particles during use of the apparatus.

34. The suction enabled dental instrument apparatus according to embodiments 1-33, wherein the instrument opening is shaped as a semicircle positioned above and coterminous with a relatively smaller circle.

35. The suction enabled dental instrument apparatus according to embodiments 1-34, wherein the interface end of the handpiece provides an electrical port in electrical communication with an at least one power source for selectively powering one or more of the instrument portion, the fluid source, and the suction source.

36. The suction enabled dental instrument apparatus according to embodiments 1-35, wherein one or more of the electrical port, fluid port and suction port are positioned within a single conduit extending from the interface end of the handpiece.

37. The suction enabled dental instrument apparatus according to embodiments 1-36, wherein the conduit is in fluid communication with the suction source, with one or both of the fluid port and electrical port being positioned within the conduit.

38. The suction enabled dental instrument apparatus according to embodiments 1-37, wherein an outer surface of the handpiece provides a resilient, soft, deformable grip portion positioned and configured for increasing comfort, reducing vibration transmission, and reducing muscle activity in a user's hand during use of the apparatus, while also preserving manual dexterity.

39. The suction enabled dental instrument apparatus according to embodiments 1-38, wherein the working end of the handpiece is removably engageable with the interface end of the handpiece.

40. The suction enabled dental instrument apparatus according to embodiments 1-39, wherein: the interface end of the handpiece provides a plurality of spaced apart, radially arranged rails configured for frictionally engaging a circumferential inner surface of the working end of the handpiece when the working end is slid overtop of the rails; whereby, with the interface end frictionally engaged with the working end, the inner surface of the working end cooperates with spaces between the rails to define the at least one suction lumen.

41. The suction enabled dental instrument apparatus according to embodiments 1-40, wherein the inner surface of the working end provides a plurality of corresponding slots positioned and configured for slidably receiving the rails of the interface end.

42. The suction enabled dental instrument apparatus according to embodiments 1-41, wherein the suction inlet end of each of the at least one suction lumen provides a chamfered edge so as to optimize airflow for dental spray removal during use of the apparatus.

43. The suction enabled dental instrument apparatus according to embodiments 1-42, wherein the main lumen has an inner diameter of approximately 1/24 inch-2 inches.

44. The suction enabled dental instrument apparatus according to embodiments 1-43, wherein the at least one suction lumen has an inner diameter of approximately ¼ inch-2 inches.

45. A suction enabled dental instrument apparatus comprising: an elongate handpiece having a working end and an opposing interface end; a terminal face of the working end of the handpiece providing an instrument opening sized and configured for allowing an instrument end of an instrument portion positioned within the handpiece to extend a distance therethrough; a main lumen positioned within the handpiece and extending between a main outlet end, positioned adjacent to and in fluid communication with the instrument opening, and an opposing main inlet end, positioned proximal to the interface end of the handpiece and in fluid communication with a fluid source, the main outlet end configured for selectively delivering a volume of fluid from the fluid source during use of the apparatus; an at least one suction lumen positioned within the handpiece and extending between a suction inlet end, positioned adjacent to and in fluid communication with the instrument opening, and an opposing suction outlet end, positioned proximal to the interface end of the handpiece and in fluid communication with a suction source, the suction inlet end configured for capturing fluids and dental spray generated proximal to the instrument opening during use of the apparatus for the suction source to subsequently remove via the suction outlet end; and the instrument portion substantially coaxially positioned within the main outlet end of the main lumen, such that a perimeter edge of the instrument opening is radially spaced apart from and extends circumferentially about the instrument end of the instrument portion.

46. A suction enabled dental instrument apparatus comprising: an elongate handpiece having a working end and an opposing interface end; a terminal face of the working end of the handpiece providing an instrument opening sized and configured for allowing an instrument end of an instrument portion positioned within the handpiece to extend a distance therethrough; a main lumen positioned within the handpiece and extending between a main outlet end, positioned adjacent to and in fluid communication with the instrument opening, and an opposing main inlet end, positioned proximal to the interface end of the handpiece and in fluid communication with a fluid source, the main outlet end configured for selectively delivering a volume of fluid from the fluid source during use of the apparatus; an at least one suction lumen positioned within the handpiece and extending between a suction inlet end, positioned adjacent to and in fluid communication with the instrument opening, and an opposing suction outlet end, positioned proximal to the interface end of the handpiece and in fluid communication with a suction source, the suction inlet end configured for capturing fluids and dental spray generated proximal to the instrument opening during use of the apparatus for the suction source to subsequently remove via the suction outlet end; the instrument portion substantially coaxially positioned within the main outlet end of the main lumen, such that a perimeter edge of the instrument opening is radially spaced apart from and extends circumferentially about the instrument end of the instrument portion; and the working end of the handpiece being tapered toward the instrument opening, with an outer surface of the working end and the perimeter edge of the instrument opening defining a plurality of circumferentially arranged indentations extending substantially longitudinally from the instrument opening toward the interface end of the handpiece.

In closing, regarding the exemplary embodiments of the present invention as shown and described herein, it will be appreciated that a suction enabled dental instrument apparatus is disclosed and configured for capturing dental spray during use of the dental instrument and reducing risk of airborne infections. Because the principles of the invention may be practiced in a number of configurations beyond those shown and described, it is to be understood that the invention is not in any way limited by the exemplary embodiments, but is generally directed to a suction enabled dental instrument apparatus and is able to take numerous forms to do so without departing from the spirit and scope of the invention. It will also be appreciated by those skilled in the art that the present invention is not limited to the particular geometries and materials of construction disclosed, but may instead entail other functionally comparable structures or materials, now known or later developed, without departing from the spirit and scope of the invention.

Certain embodiments of the present invention are described herein, including the best mode known to the inventor(s) for carrying out the invention. Of course, variations on these described embodiments will become apparent to those of ordinary skill in the art upon reading the foregoing description. The inventor(s) expect skilled artisans to employ such variations as appropriate, and the inventor(s) intend for the present invention to be practiced otherwise than specifically described herein. Accordingly, this invention includes all modifications and equivalents of the subject matter recited in the claims appended hereto as permitted by applicable law. Moreover, any combination of the above-described embodiments in all possible variations thereof is encompassed by the invention unless otherwise indicated herein or otherwise clearly contradicted by context.

Groupings of alternative embodiments, elements, or steps of the present invention are not to be construed as limitations. Each group member may be referred to and claimed individually or in any combination with other group members disclosed herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Unless otherwise indicated, all numbers expressing a characteristic, item, quantity, parameter, property, term, and so forth used in the present specification and claims are to be understood as being modified in all instances by the terms “about” and “approximately.” As used herein, the terms “about” and “approximately” mean that the characteristic, item, quantity, parameter, property, or term so qualified encompasses a range of plus or minus ten percent above and below the value of the stated characteristic, item, quantity, parameter, property, or term. Accordingly, unless indicated to the contrary, the numerical parameters set forth in the specification and attached claims are approximations that may vary. At the very least, and not as an attempt to limit the application of the doctrine of equivalents to the scope of the claims, each numerical indication should at least be construed in light of the number of reported significant digits and by applying ordinary rounding techniques. Notwithstanding that the numerical ranges and values setting forth the broad scope of the invention are approximations, the numerical ranges and values set forth in the specific examples are reported as precisely as possible. Any numerical range or value, however, inherently contains certain errors necessarily resulting from the standard deviation found in their respective testing measurements. Recitation of numerical ranges of values herein is merely intended to serve as a shorthand method of referring individually to each separate numerical value falling within the range. Unless otherwise indicated herein, each individual value of a numerical range is incorporated into the present specification as if it were individually recited herein. Similarly, as used herein, unless indicated to the contrary, the term “substantially” is a term of degree intended to indicate an approximation of the characteristic, item, quantity, parameter, property, or term so qualified, encompassing a range that can be understood and construed by those of ordinary skill in the art.

Use of the terms “may” or “can” in reference to an embodiment or aspect of an embodiment also carries with it the alternative meaning of “may not” or “cannot.” As such, if the present specification discloses that an embodiment or an aspect of an embodiment may be or can be included as part of the inventive subject matter, then the negative limitation or exclusionary proviso is also explicitly meant, meaning that an embodiment or an aspect of an embodiment may not be or cannot be included as part of the inventive subject matter. In a similar manner, use of the term “optionally” in reference to an embodiment or aspect of an embodiment means that such embodiment or aspect of the embodiment may be included as part of the inventive subject matter or may not be included as part of the inventive subject matter. Whether such a negative limitation or exclusionary proviso applies will be based on whether the negative limitation or exclusionary proviso is recited in the claimed subject matter.

The terms “a,” “an,” “the” and similar references used in the context of describing the present invention (especially in the context of the following claims) are to be construed to cover both the singular and the plural, unless otherwise indicated herein or clearly contradicted by context. Further, ordinal indicators—such as “first,” “second,” “third,” etc.—for identified elements are used to distinguish between the elements, and do not indicate or imply a required or limited number of such elements, and do not indicate a particular position or order of such elements unless otherwise specifically stated. All methods described herein can be performed in any suitable order unless otherwise indicated herein or otherwise clearly contradicted by context. The use of any and all examples, or exemplary language (e.g., “such as”) provided herein is intended merely to better illuminate the present invention and does not pose a limitation on the scope of the invention otherwise claimed. No language in the present specification should be construed as indicating any non-claimed element essential to the practice of the invention.

When used in the claims, whether as filed or added per amendment, the open-ended transitional term “comprising” (along with equivalent open-ended transitional phrases thereof such as “including,” “containing” and “having”) encompasses all the expressly recited elements, limitations, steps and/or features alone or in combination with un-recited subject matter; the named elements, limitations and/or features are essential, but other unnamed elements, limitations and/or features may be added and still form a construct within the scope of the claim. Specific embodiments disclosed herein may be further limited in the claims using the closed-ended transitional phrases “consisting of” or “consisting essentially of” in lieu of or as an amendment for “comprising.” When used in the claims, whether as filed or added per amendment, the closed-ended transitional phrase “consisting of” excludes any element, limitation, step, or feature not expressly recited in the claims. The closed-ended transitional phrase “consisting essentially of” limits the scope of a claim to the expressly recited elements, limitations, steps and/or features and any other elements, limitations, steps and/or features that do not materially affect the basic and novel characteristic(s) of the claimed subject matter. Thus, the meaning of the open-ended transitional phrase “comprising” is being defined as encompassing all the specifically recited elements, limitations, steps and/or features as well as any optional, additional unspecified ones. The meaning of the closed-ended transitional phrase “consisting of” is being defined as only including those elements, limitations, steps and/or features specifically recited in the claim, whereas the meaning of the closed-ended transitional phrase “consisting essentially of” is being defined as only including those elements, limitations, steps and/or features specifically recited in the claim and those elements, limitations, steps and/or features that do not materially affect the basic and novel characteristic(s) of the claimed subject matter. Therefore, the open-ended transitional phrase “comprising” (along with equivalent open-ended transitional phrases thereof) includes within its meaning, as a limiting case, claimed subject matter specified by the closed-ended transitional phrases “consisting of” or “consisting essentially of.” As such, embodiments described herein or so claimed with the phrase “comprising” are expressly or inherently unambiguously described, enabled and supported herein for the phrases “consisting essentially of” and “consisting of.”

Any claims intended to be treated under 35 U.S.C. § 112(f) will begin with the words “means for,” but use of the term “for” in any other context is not intended to invoke treatment under 35 U.S.C. § 112(f). Accordingly, Applicant reserves the right to pursue additional claims after filing this application, in either this application or in a continuing application.

It should be understood that the methods and the order in which the respective elements of each method are performed are purely exemplary. Depending on the implementation, they may be performed in any order or in parallel, unless indicated otherwise in the present disclosure.

All patents, patent publications, and other publications referenced and identified in the present specification are individually and expressly incorporated herein by reference in their entirety for the purpose of describing and disclosing, for example, the compositions and methodologies described in such publications that might be used in connection with the present invention. These publications are provided solely for their disclosure prior to the filing date of the present application. Nothing in this regard should be construed as an admission that the inventors are not entitled to antedate such disclosure by virtue of prior invention or for any other reason. All statements as to the date or representation as to the contents of these documents is based on the information available to the applicants and does not constitute any admission as to the correctness of the dates or contents of these documents.

While aspects of the invention have been described with reference to at least one exemplary embodiment, it is to be clearly understood by those skilled in the art that the invention is not limited thereto. Rather, the scope of the invention is to be interpreted only in conjunction with the appended claims and it is made clear, here, that the inventor(s) believe that the claimed subject matter is the invention.

What is claimed is:

1. A suction enabled dental instrument apparatus comprising:
an elongate handpiece having a working end and an opposing interface end;
a terminal face of the working end of the handpiece providing an instrument opening sized and configured for allowing an instrument end of an instrument portion positioned within the handpiece to extend a distance therethrough;
a main lumen positioned within the handpiece and extending between a main outlet end, positioned adjacent to and in fluid communication with the instrument opening, and an opposing main inlet end, positioned proximal to the interface end of the handpiece and in fluid communication with a fluid source, the main outlet end configured for selectively delivering a volume of fluid from the fluid source during use of the apparatus; and
an at least one suction lumen positioned within the handpiece and extending between a suction inlet end, positioned adjacent to and in fluid communication with the instrument opening, and an opposing suction outlet end, positioned proximal to the interface end of the handpiece and in fluid communication with a suction source, the suction inlet end configured for capturing fluids and dental spray generated proximal to the instrument opening during use of the apparatus for the suction source to subsequently remove via the suction outlet end.

2. The suction enabled dental instrument apparatus of claim 1, further comprising a plurality of suction lumens positioned within the handpiece, the suction lumens being arranged circumferentially about the main lumen.

3. The suction enabled dental instrument apparatus of claim 1, wherein the main lumen is substantially coaxially positioned within the suction lumen.

4. The suction enabled dental instrument apparatus of claim 1, wherein the instrument end of the instrument portion extends approximately 0.6-2.0 cm beyond the terminal face of the working end of the handpiece.

5. The suction enabled dental instrument apparatus of claim 1, wherein the instrument portion is substantially coaxially positioned within the main outlet end of the main lumen, such that a perimeter edge of the instrument opening is radially spaced apart from and extends circumferentially about the instrument end of the instrument portion.

6. The suction enabled dental instrument apparatus of claim 1, wherein the working end of the handpiece is tapered toward the instrument opening.

7. The suction enabled dental instrument apparatus of claim 1, wherein the instrument opening has a shape that is substantially non-circular.

8. The suction enabled dental instrument apparatus of claim 1, wherein a base of the instrument portion is positioned within the main lumen, the base having an outer diameter that is relatively greater than an inner diameter of the main outlet end of the main lumen, thereby preventing the base from passing through the main outlet end of the main lumen.

9. The suction enabled dental instrument apparatus of claim 8, wherein the instrument portion provides an instrument shaft extending between and interconnecting the instrument end and the base, the instrument shaft having an outer diameter that is relatively less than an inner diameter of the main outlet end of the main lumen.

10. The suction enabled dental instrument apparatus of claim 9, wherein the instrument shaft is substantially coaxially positioned within the main outlet end of the main lumen, such that the main outlet end is radially spaced apart from and extends circumferentially about the instrument shaft, thereby maintaining fluid communication between the instrument opening and the main lumen.

11. The suction enabled dental instrument apparatus of claim 8, wherein the base of the instrument portion provides an at least one instrument aperture extending therethrough in a direction substantially parallel with the main lumen for facilitating the fluid communication between the instrument opening and the main lumen.

12. The suction enabled dental instrument apparatus of claim 1, further comprising an at least one debris trap positioned in-line between the instrument opening and the suction source, the at least one debris trap configured for capturing any debris that might be sucked into the instrument opening via the at least one suction lumen.

13. The suction enabled dental instrument apparatus of claim 1, further comprising a porous nozzle positioned within the instrument opening and providing a plurality of circumferentially arranged nozzle apertures sized and configured for assisting with the capture of dental spray particles during use of the apparatus.

14. The suction enabled dental instrument apparatus of claim 1, wherein an outer surface of the handpiece provides a resilient, soft, deformable grip portion positioned and configured for increasing comfort, reducing vibration transmission, and reducing muscle activity in a user's hand during use of the apparatus, while also preserving manual dexterity.

15. The suction enabled dental instrument apparatus of claim 1, wherein the working end of the handpiece is removably engageable with the interface end of the handpiece.

16. The suction enabled dental instrument apparatus of claim 15, wherein:
the interface end of the handpiece provides a plurality of spaced apart, radially arranged rails configured for frictionally engaging a circumferential inner surface of the working end of the handpiece when the working end is slid overtop of the rails;
whereby, with the interface end frictionally engaged with the working end, the inner surface of the working end cooperates with spaces between the rails to define the at least one suction lumen.

17. The suction enabled dental instrument apparatus of claim 16, wherein the inner surface of the working end provides a plurality of corresponding slots positioned and configured for slidably receiving the rails of the interface end.

18. The suction enabled dental instrument apparatus of claim 16, wherein the suction inlet end of each of the at least one suction lumen provides a chamfered edge so as to optimize airflow for dental spray removal during use of the apparatus.

19. A suction enabled dental instrument apparatus comprising:
an elongate handpiece having a working end and an opposing interface end;
a terminal face of the working end of the handpiece providing an instrument opening sized and configured for allowing an instrument end of an instrument portion positioned within the handpiece to extend a distance therethrough;
a main lumen positioned within the handpiece and extending between a main outlet end, positioned adjacent to and in fluid communication with the instrument opening, and an opposing main inlet end, positioned proximal to the interface end of the handpiece and in fluid communication with a fluid source, the main outlet end configured for selectively delivering a volume of fluid from the fluid source during use of the apparatus;
an at least one suction lumen positioned within the handpiece and extending between a suction inlet end, positioned adjacent to and in fluid communication with the instrument opening, and an opposing suction outlet end, positioned proximal to the interface end of the handpiece and in fluid communication with a suction source, the suction inlet end configured for capturing fluids and dental spray generated proximal to the instrument opening during use of the apparatus for the suction source to subsequently remove via the suction outlet end; and
the instrument portion substantially coaxially positioned within the main outlet end of the main lumen, such that a perimeter edge of the instrument opening is radially spaced apart from and extends circumferentially about the instrument end of the instrument portion.

20. A suction enabled dental instrument apparatus comprising:
an elongate handpiece having a working end and an opposing interface end;
a terminal face of the working end of the handpiece providing an instrument opening sized and configured for allowing an instrument end of an instrument portion positioned within the handpiece to extend a distance therethrough;
a main lumen positioned within the handpiece and extending between a main outlet end, positioned adjacent to and in fluid communication with the instrument opening, and an opposing main inlet end, positioned proximal to the interface end of the handpiece and in fluid communication with a fluid source, the main outlet end configured for selectively delivering a volume of fluid from the fluid source during use of the apparatus;
an at least one suction lumen positioned within the handpiece and extending between a suction inlet end, positioned adjacent to and in fluid communication with the instrument opening, and an opposing suction outlet end, positioned proximal to the interface end of the handpiece and in fluid communication with a suction source, the suction inlet end configured for capturing fluids and dental spray generated proximal to the instrument opening during use of the apparatus for the suction source to subsequently remove via the suction outlet end;
the instrument portion substantially coaxially positioned within the main outlet end of the main lumen, such that a perimeter edge of the instrument opening is radially spaced apart from and extends circumferentially about the instrument end of the instrument portion; and
the working end of the handpiece being tapered toward the instrument opening, with an outer surface of the working end and the perimeter edge of the instrument opening defining a plurality of circumferentially arranged indentations extending substantially longitudinally from the instrument opening toward the interface end of the handpiece.
